(19) United States
(12) Patent Application Publication
(10) Pub. No.: US 2014/0235396 A1
(43) Pub. Date: Aug. 21, 2014

(54) Transmission

(71) Applicant: Anthony James Dupont, Boise, ID (US)

(72) Inventor: Anthony James Dupont, Boise, ID (US)

(21) Appl. No.: 13/815,318

(22) Filed: Feb. 19, 2013

(51) Int. Cl. F16H 15/52

(52) U.S. Cl. CPC F16H 15/52
USPC 475/190

(57) ABSTRACT

An infinitely variable transmission that utilizes a wobbler in driving engagement with a planetary gear arrangement. The planetary gear arrangement drives a sun gear that provides an output from the transmission. As the tilt angle of the wobbler is adjusted, the overall speed reduction (or increase) ratio of the transmission is adjusted. It is possible to adjust the output speed all the way to zero depending on the tilt angle of the wobbler. In the present invention, two or more drives with two or more wobblers and two or more planetary and sun gears are utilized so that torque can be divided between multiple drives and so that cyclical variations in the output speed of the transmission are smoothed

### RELATED PATENTS

This application is a Continuation In Part of co-pending U.S. patent application Ser. No. 12/450,831 which was filed on Mar. 8, 2010. U.S. patent application Ser. No. 12/450,831 and is incorporated herein by reference in its entirety.

### BACKGROUND OF THE INVENTION

Power sources such as electric motors, internal combustion engines, and humans typically generate power most efficiently when operating within a narrow range of speeds, while a specific application for the power, a wheeled vehicle for example, might require a broad range of speeds. A transmission is often used to adapt the speed characteristics of the power generator to the speed characteristics of the power application. Many transmissions function, for example, as rotary speed changers. Transmissions are also used to convert one kind of motion to another kind of motion, converting a rotary motion input to a linear motion output for example.

Transmissions may provide a torque-speed conversion from a higher speed motor to a slower but more forceful output, reducing the speed from the input to the output, or from a slower speed motor to a faster but less forceful output, increasing the speed from the input to the output. An infinitely variable transmission (IVT) is a transmission in which the ratio of the torque and speeds of the input and the output can be varied continuously within a given range, providing an infinite number of possible output torque-speed ratios within that range including zero speed.

A novel IVT was described in U.S. patent application Ser. No. 12/450,831. The transmission presented in that application is successful at providing an infinite number of speed ratios within a limited range. However, it is limited in the amount of torque that can be transmitted through the transmission. As the output speeds approach zero the following loads on the wobbler and the freewheeling gear can be significant and limit the applications for this transmission. It would be desirable to provide an infinitely variable transmission such as that described in U.S. patent application Ser. No. 12/450,831 that is capable of carrying a higher torque load. Furthermore, the output speed of the transmission described in U.S. patent application Ser. No. 12/450,831 experiences cyclic variations with a frequency of six pulses per rotation of the input shaft. It would be desirable to provide a transmission that has reduced amplitude of cyclic speed variations in the output shaft for applications that require a smoother output.

### SUMMARY OF THE INVENTION

The present invention is a modification of the infinitely variable transmission described in U.S. patent application Ser. No. 12/450,831 by adding additional transmission units in parallel to allow a higher torque load to be carried by the transmission. Two transmissions are mounted on a common input shaft, with torque being split between the two transmissions. Output of the two transmissions is consolidated into a single output shaft. By utilizing two transmissions in parallel, the torque load capability of the combined transmission is effectively doubled.

While one embodiment of the present invention includes two transmissions in parallel, it would be possible to construct other embodiments of the transmission utilizing three or more transmissions in parallel in a similar manner to triple or more than triple the torque carrying capability of the transmission.

### BRIEF DESCRIPTION OF THE DRAWINGS

FIG. 1 is a perspective view of the transmissions, according to the embodiment of the invention

FIG. 2 is an exploded perspective view of the transmission assembly shown in FIG. 1.

FIG. 3 is a perspective view of the stacked planetary gear set shown in FIG. 2.

FIG. 4 is an exploded view of the stacked planetary gear set shown in FIGS. 2 and 3.

FIG. 5 is a perspective view of the input drive and shifting linage system in the transmission shown in FIG. 2.

FIG. 6 is an exploded view of the shifting linkage system in the transmission shown in FIGS. 2 and 5.

FIG. 7 is a perspective view of the input shafts and wobbler assemblies.

FIG. 8 is an exploded view of a second input drive shaft including a support ball assembly.

### DETAILED DESCRIPTION OF THE INVENTION

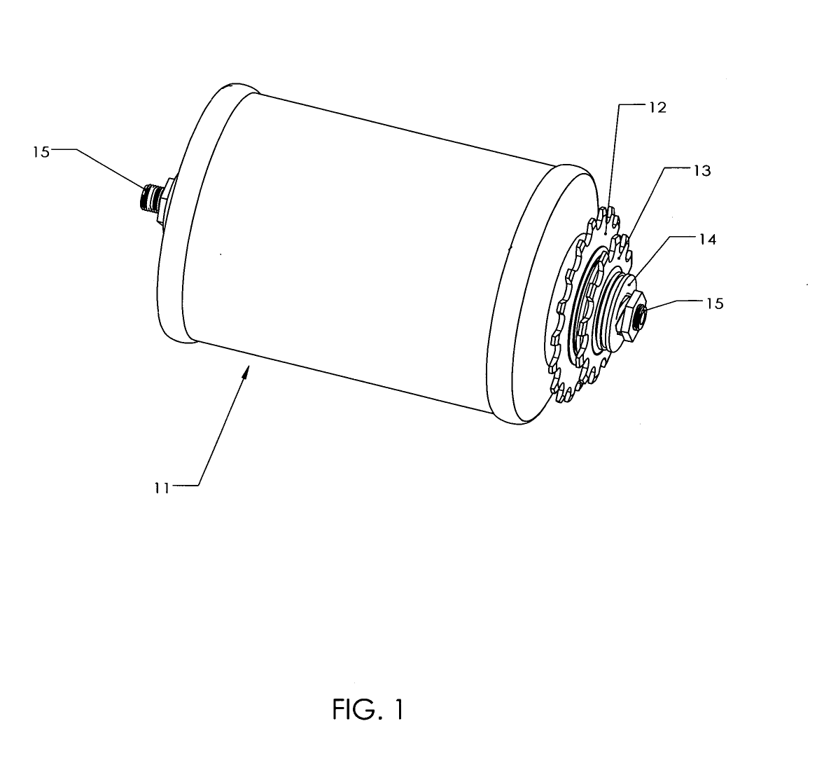

The present invention will be described with reference to FIGS. 1-8. Many aspects of the present invention are the same as previously described in U.S. patent application Ser. No. 12/450,831, which is incorporated herein by reference in its entirety. Some details of the transmission can be found in that document and are omitted here.

FIG. 1 shows a transmission that includes a hub 11 which encloses many of the parts of the transmission. The hub 11 rotates as the transmission is driven and is connected to output sprocket 12. Output sprocket 12 rotates together with hub 11. The entire transmission is supported on axle 15. Axle 15 is mounted to be stationary, where stationary means fixed relative to the device on which the transmission is used. For example, axle 15 could be mounted on a bicycle, vehicle, wind turbine, or other piece of machinery. Axle 15, however, is not contemplated to rotate during operation of the transmission. It should be noted that U.S. patent application Ser. No. 12/450,831 described two embodiments of the invention, one in which a wobbler rotates and a cage is stationary, and one in which the wobbler is stationary and the cage rotates. Either embodiment could be utilized with the present invention, but the description given here is in reference to the first embodiment in which the wobbler rotates and the cage is stationary and fixed to the axle. In fact, it would be possible to drive the wobbler one direction and the cage in the opposite direction. The requirement is that at least one of the axle, the cage, or the follower portion of the wobbler must be held stationary. It is possible to hold two of these items stationary, for example in the description given here where the axle and the cage are both held stationary. However, at least one of these three items must be held stationary against rotation in order for the transmission to function. An input sprocket 13 is mounted concentrically around the axle 15 for rotation thereupon. A shifting assembly 14 is attached to the input sprocket 13. The shifting assembly is substantially similar to that described in U.S. patent application Ser. No. 12/450,831. An output sprocket 12 is attached to hub 11 for rotation therewith. While the present invention is shown with sprockets 12, 13 for input and output of power and torque, any other suitable connection to the input and output of the transmission could be used, as would be appreciated by one of ordinary skill in the art. For example, the sprockets 12, 13 could be replaced with sheaves that work with v-belts. They could also be replaced with splined connections to other drive shafts. Many other suitable connections for input and output of power and torque can be contemplated and are known to those of ordinary skill in the art.

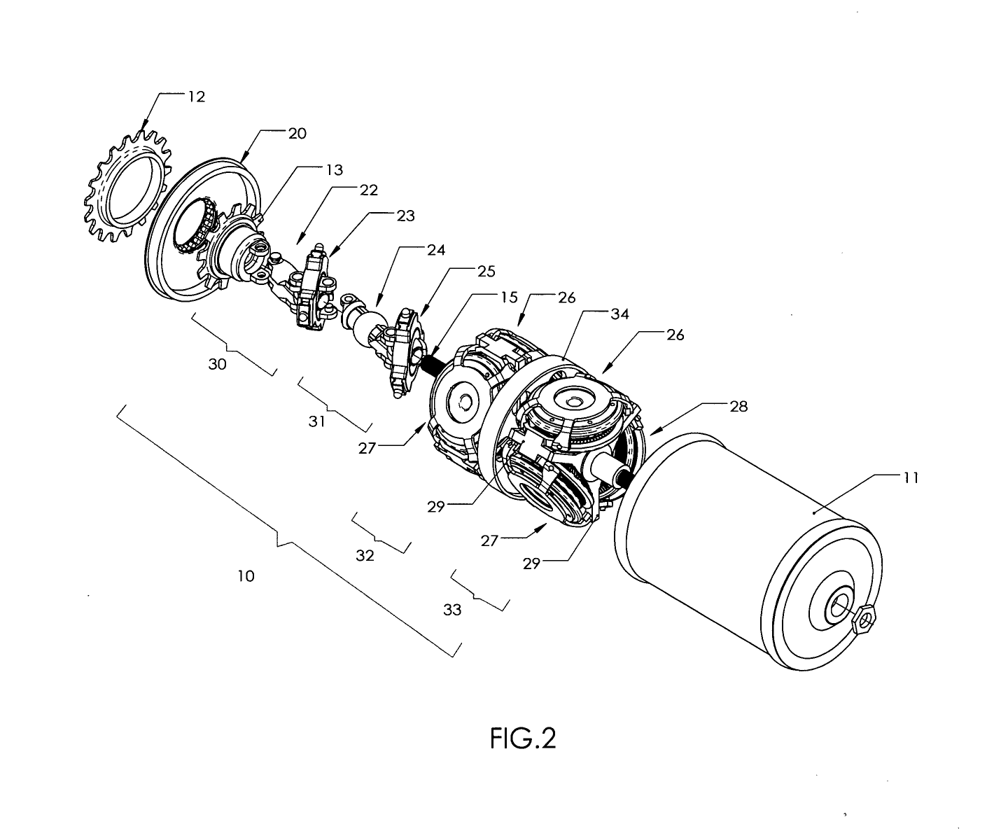

FIG. 2 shows an exploded view of the transmission of the present invention. It can be seen in FIG. 2 that input sprocket 13 is drivingly connected to a first drive shaft 22 which drives a first wobbler assembly 23. A second drive shaft 24 is drivingly connected to the first wobbler assembly 23 for rotation therewith. The second drive shaft 24 rotates along with the first wobbler assembly 23 during operation of the transmission. The second drive shaft 24 is drivingly connected to a second wobbler assembly 25. Both drive shafts 22, 24 and both wobbler assemblies 23, 25 are supported for rotation on axle 15. Wobbler assemblies 23, 25 operate together with first and second planetary gear assemblies 32, 33, respectively. Each of the planetary gear assemblies 32, 33 includes three planetary gear sets 26, 27, 28. The planetary gear sets 26, 27, 28 are supported by a cage 29 which is fixedly secured to the axle 15. The planetary gear sets 26, 27, 28 are all substantially similar to the planetary gear sets described in U.S. patent application Ser. No. 12/450,831. The planetary gear sets 26, 27, 28 in each of the two planetary gear assemblies 32, 33 mate with a respective sun gear that is fixedly attached to an output speed disk 34. Output speed disk is attached to hub 11 for rotation therewith such that hub 11 is driven when planetary gear sets 26, 27, 28 drive the sun gears and the output speed disk 34.

The arrangement shown results in input torque being split between wobbler assembly 1 and wobbler assembly 2. Therefore, operational loads are shared by the two planetary gear assemblies and the loads in each assembly are cut in half compared to using a single drive. Drive torque from each of the planetary gear assemblies is transmitted to a respective sun gear and recombined in the output speed disk 34 such that all of the drive torque is transmitted through hub 11 and to output sprocket 12 via a hub side cover 20.

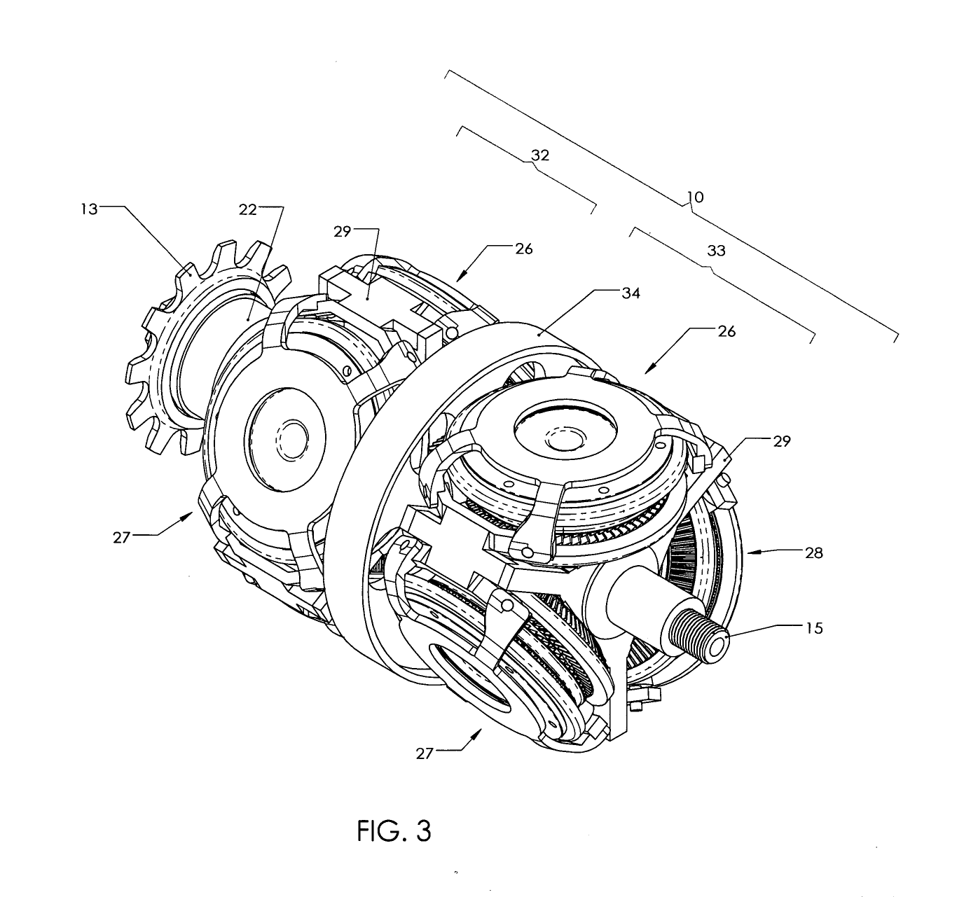

FIG. 3 shows details of the first and second planetary gear assemblies 32, 33 of the transmission 10. It can be seen that each planetary gear assembly 32, 33 includes three planetary gear sets 26, 27, 28. The planetary gear sets 26, 27, 28 are contemplated as including a freewheeling clutch as described in U.S. patent application Ser. No. 12/450,831. Details of the planetary gear sets and freewheeling clutches are not repeated here. The planetary gear sets are supported by cage 29 which is fixedly attached to axle 15. Output power and torque are transmitted through output speed disk 34.

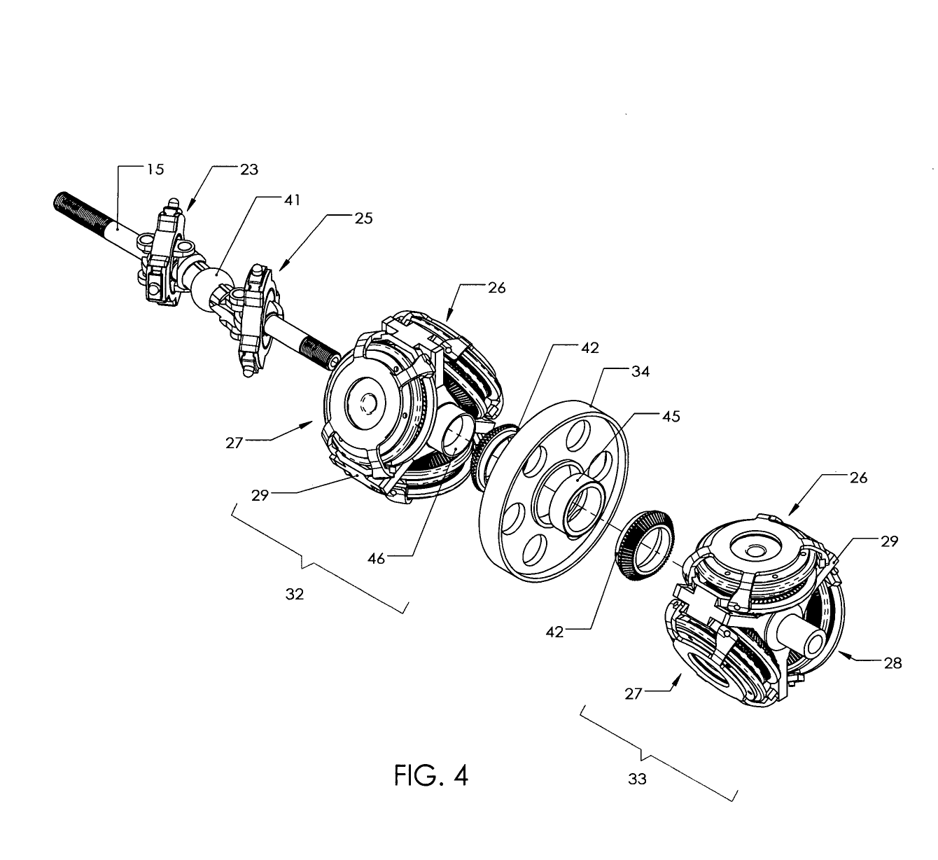

FIG. 4 shows an exploded view of the internal components of the transmission of the present invention. The entire transmission is supported on axle 15. First and second wobbler assemblies 23, 25 are supported for rotation on the axle 15. The mechanisms for supporting the wobbler assemblies 23, 25 are substantially similar to that described in U.S. patent application Ser. No. 12/450,831 with a round bearing with arcuate ridges and mating arcuate slots in the wobblers. Details of the wobbler support mechanism are incorporated by reference from U.S. patent application Ser. No. 12/450,831 and are not provided herein. The wobbler assemblies 23, 25 mate with planetary gear assemblies 32, 33. Planetary gear assemblies 32, 33 include planetary gear sets 26, 27, 28 that mate with first and second sun gears 42. The sun gears are fixedly mounted to output speed disk for rotation therewith. The wobbler assemblies drive planetary gear sets 26, 27, 28 through drive posts on the wobblers that engage an arcuate drive track on a planetary gear. Details of the interaction between the wobbler and the planetary gear are substantially similar to that described in U.S. patent application Ser. No. 12/450,831 and are incorporated herein by reference without detailed description being provided in the present application.

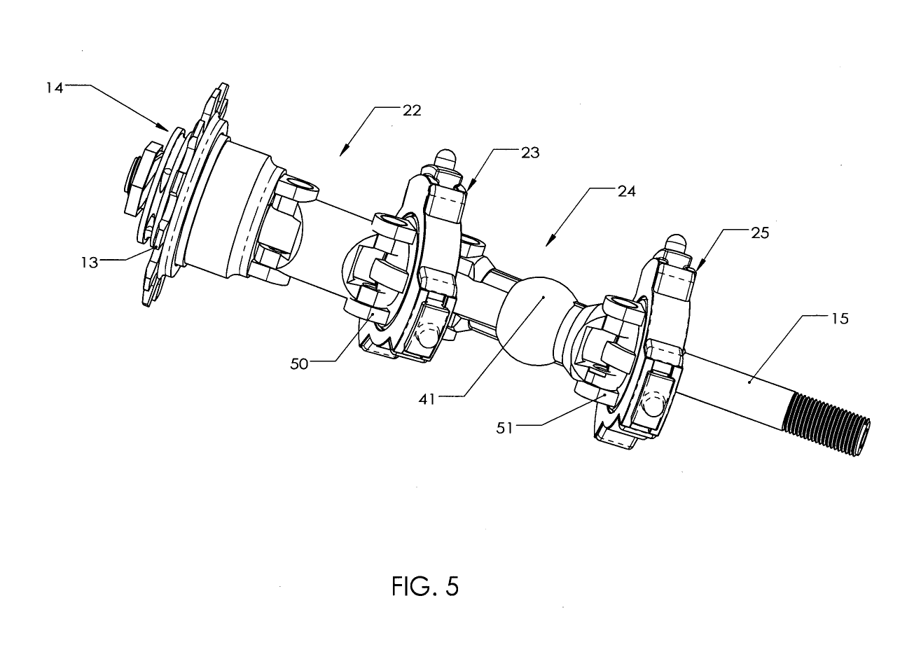

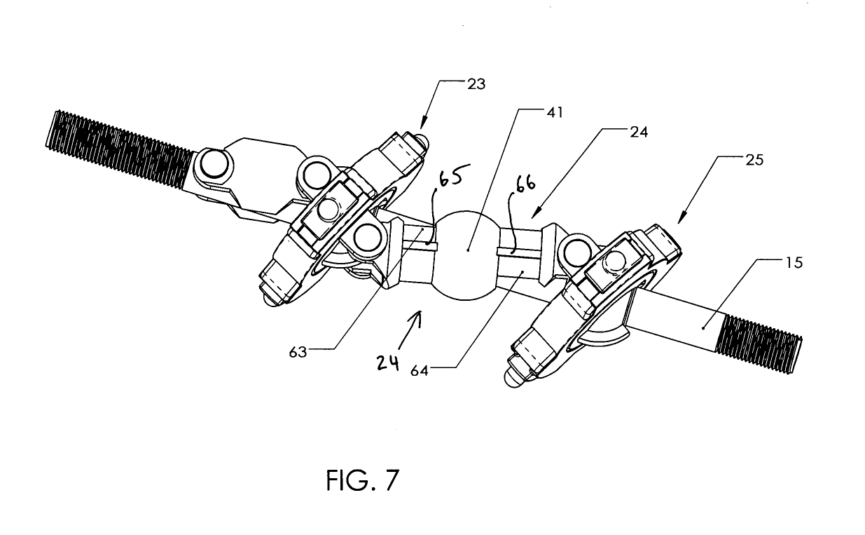

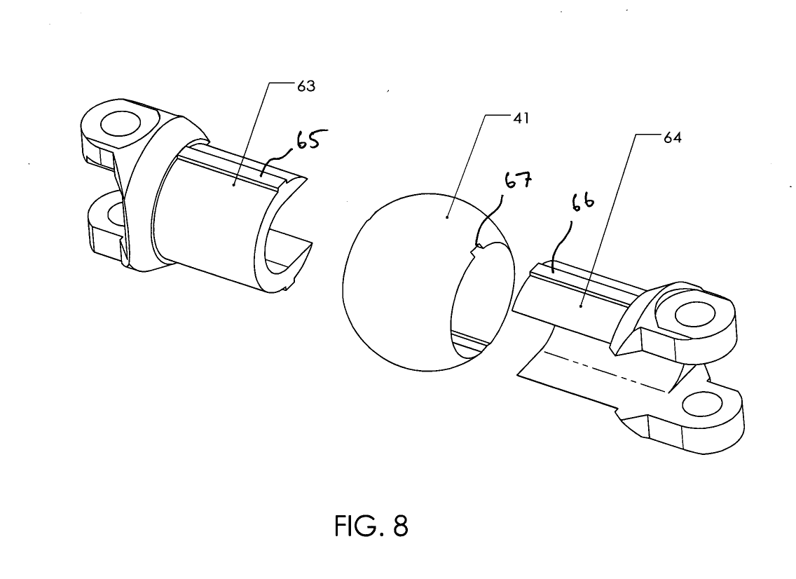

FIG. 5 shows detail of the input shaft and connections with the wobbler assemblies 23, 25. The arrangement shown in FIG. 5 allows the two wobblers to be tilted together so that the two drives have the same speed reduction (or increase) ratio. An input sprocket 13 is attached to a first drive shaft 22. The first drive shaft 22 is pinned or gimbaled to the input sprocket via a hinge that allows the first input shaft 22 to be tilted relative to sprocket 13. A shifter assembly 14 is attached to input sprocket 13. When the shifter assembly 14 is rotated relative to input sprocket 13 it translates in or out and thereby tilts the first drive shaft 22. First drive shaft 22 is pinned or gimbaled to the first wobbler assembly 23 via a hinge. When the first drive shaft 22 is tilted by the shifter assembly, the first wobbler assembly 23 is also tilted. Details of this shifting mechanism are substantially similar to that described in U.S. patent application Ser. No. 12/450,831 and are incorporated by reference and not described in detail here. The first wobbler assembly 23 is pinned or gimbaled to a second drive shaft 24 and the second drive shaft 24 is pinned or gimbaled to the second wobbler assembly 25. When the first wobbler assembly 23 is tilted by the shifting mechanism, the second drive shaft 24 causes the second wobbler assembly 25 to tilt by the same amount. The second drive shaft 24 is supported on the axle 15 by a support ball 41. Also, the support ball 41 allows the length of the second drive shaft 24 to increase or decrease. Details of the second drive shaft 24 and the support ball 41 are given later in reference to FIGS. 7 and 8.

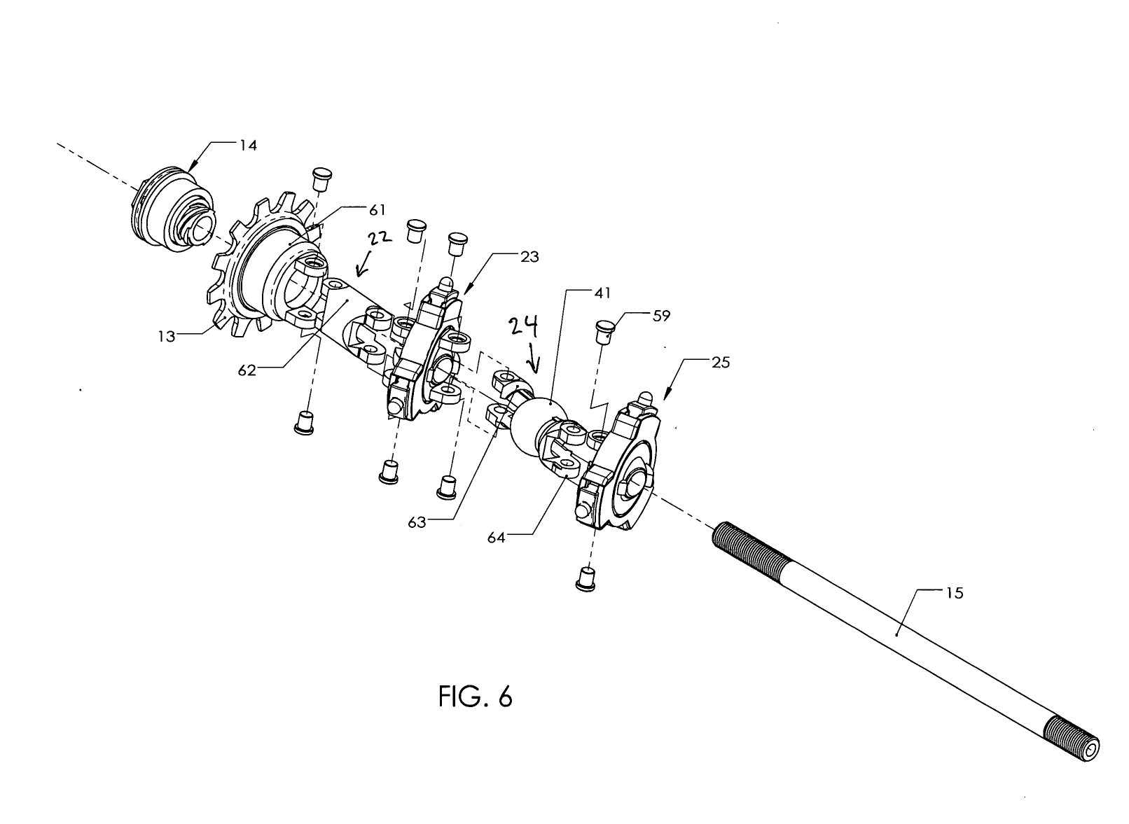

FIG. 6 shows an exploded view of the input sprocket 13, input shafts 22, 24, and wobbler assemblies 23, 25. It can be seen that the first drive shaft 22 includes a shaft segment 62 that is attached to input sprocket segment 61 and to the first wobbler assembly 23 via pins 59. The second drive shaft 24 is attached to the first wobbler assembly 23 and the second wobbler assembly 25 via pins. The second drive shaft 24 is fabricated with first and second drive shafts 63, 64 connected with support ball 41. The support ball 41 is supported on axle 15 to allow rotation and rocking. The support ball 41 forms a pivot point in the center of drive shaft 24.

FIGS. 7 and 8 show details of the input shafts and wobbler assemblies with special attention to second input shaft 24. The second input shaft 24 includes a first shaft segment 63 and a second shaft segment 64. Each of the shaft segments 63, 64 are held captive by the support ball 41. Support ball 41 is supported on axle 15 for rotation thereabout. The support ball 41 is allowed to tilt relative to axle 15 but it cannot translate radially relative to axle 15. Ridges 65, 66 on the exterior portions of shaft segments 65, 66 fit into mating slots 67 in the support ball. The ridges 65, 66 and slots 67 allow the shaft segments 63, 64 to slide within the support ball 41 to increase or decrease the overall length of the second input shaft 24. If the second input shaft were not held at its midpoint by support ball 41 then the second wobbler assembly would not be tilted when the shifter mechanism is moved. Also, if the second input drive shaft 24 could not be adjusted in length then the entire mechanism would become jammed.

The description provided herein discusses a linkage that tilts the two wobblers in unison. However, it is contemplated that separate shifting mechanisms could be provided for the two wobblers such that they can be tilted independently. This would allow the two infinitely variable speed adjusters to have different speed reduction (or increase) ratios. In this case, all of the input torque and power would be transmitted through one of the two infinitely variable speed adjusters and the freewheeling clutches in the other speed adjuster would allow that mechanism to spin freely and not carry torque or power. This mode of operation could be desirable to force all of the power and torque through a single infinitely variable speed adjuster, for example to increase efficiency at low levels of power and torque.

One of the advantages of the present invention include increased torque carrying capacity. While the invention has been described with two sets of wobblers and output drives, it would be possible to utilize three or more sets of wobblers and output drives. Each subsequent wobbler would need to be connected by an additional input drive shaft similar to the second input drive shaft 24 with a support ball mechanism that supports the midpoint of the shaft and allows the length of the shaft to be adjusted.

Another advantage of the present invention is that it smooths the output of the transmission compared to that of the transmission described in U.S. patent application Ser. No. 12/450,831. The previous transmission with a single wobbler and a single output drive pulses six times for every revolution of the input shaft. The pulsing is not especially problematic, but there could be applications where a smoother output is desired. By including a second wobbler and a second output drive assembly there are 12 pulses in the output for every revolution of the input shaft. However, the pulses are reduced in magnitude by half. Inclusion of a third or even more than three wobblers and drive assemblies would further smooth the output.

While preferred embodiments of the invention have been shown and described, it will be apparent to those skilled in the art that various modifications may be made in these embodiments without departing from the scope of the invention. Therefore, it is intended that the invention not be limited to the particular embodiments disclosed but that the scope of the invention be defined by the following claims.

I claim:

1. A transmission comprising:
an input shaft;
two wobbler assemblies drivingly connected to said input shaft and to each other such that torque from said input shaft is divided between said wobbler assemblies, each said wobbler assemblies having an outer periphery tiltable with respect to a common wobble axis of rotation;
two freewheeling gears, each disposed in a radially fixed relationship with respect to the wobble axis of rotation of a respective wobbler wherein each said wobbler assembly and each said gear are rotatable with respect to one another about the wobble axis of rotation;
wherein each said gear is in contact with and operatively connected to a respective wobbler assembly at a place on the periphery of the wobbler assembly wherein said gear rotates on its axis of rotation as the wobbler assembly wobbles; and
a common output drive that is drivingly connected to each of said freewheeling gears whereby output torque from said two freewheeling gears is combined in said common output drive.

2. The transmission of claim 1 wherein said two wobbler assemblies are connected to each other by a drive shaft wherein said drive shaft causes said two wobbler assemblies to tilt simultaneously.

3. The transmission of claim 2 wherein the length of said drive shaft is extendable such that said drive shaft can be extended or retracted as said wobbler assemblies are tilted.

4. The transmission of claim 2 wherein said drive shaft includes a support assembly that supports a midpoint on said drive shaft such that it can rotate and tilt relative to said wobbler axis of rotation but such that said midpoint is constrained against radial movement relative to said wobbler axis of rotation.

5. The transmission of claim 4 wherein the length of said drive shaft is extendable such that said drive shaft can be extended or retracted as said wobbler assemblies are tilted.

6. A transmission comprising:
an input shaft;
two infinitely variable speed adjusting mechanisms drivingly connected to said input shaft whereby input torque from said input shaft is split between said two infinitely variable speed adjusting mechanisms; and
an output shaft drivingly connected to said two infinitely variable speed adjusting mechanisms wherein torque from said two infinitely variable speed adjusting mechanisms is recombined in said output shaft.

7. The transmission of claim 6 wherein said two infinitely variable speed adjusting mechanisms are operated together to provide the same speed reduction or increase between said input shaft and said output shaft.

8. The transmission of claim 7 wherein said two infinitely variable speed adjusting mechanisms are each capable of reducing the speed of the output shaft to zero.

9. The transmission of claim 6 wherein said two infinitely variable speed adjusting mechanisms each comprise:
a wobbler assembly having an outer periphery tiltable with respect to a wobble axis of rotation;
a freewheeling gear disposed in a radially fixed relationship with respect to the wobble axis of rotation wherein the wobbler assembly and the gear are rotatable with respect to one another about the wobble axis of rotation; and
wherein said gear is in contact with and operatively connected to the wobbler assembly at a place on the periphery of the wobbler assembly wherein said place on the periphery of the wobbler assembly traces a substantially curvilinear path as said wobbler assembly wobbles such that said gear rotates on its axis of rotation as the wobbler assembly wobbles.
